(19) United States
(12) Patent Application Publication
(10) Pub. No.: US 2012/0092873 A1
(43) Pub. Date: Apr. 19, 2012

(54) LED LAMP HAVING WATERPROOF STRUCTURES

(75) Inventor: CHIH-HAO CHANG, Chu-Nan (TW)

(73) Assignee: FOXSEMICON INTEGRATED TECHNOLOGY, INC., Chu-Nan (TW)

(21) Appl. No.: 13/300,632

(22) Filed: Nov. 20, 2011

Related U.S. Application Data
(66) Substitute for application No. 12/907,044, filed on Oct. 19, 2010, now abandoned.

(51) Int. Cl. F21V 29/00

(52) U.S. Cl. 362/294

(57) ABSTRACT

An exemplary LED lamp includes a heat sink, an LED module mounted on the heat sink and a lens covering the LED module. The heat sink has a top surface and a bottom surface opposite to the top surface. The LED module is mounted on the top surface of the heat sink. A waterproof groove is defined in the top surface of the heat sink. The groove has an inner wall adjacent to the LED module and an outer wall far away from the LED module. The inner wall is higher than the outer wall. The lens has a downwardly extending flange inserted into the groove. A waterproof ring is received in the groove and pressed by the flange.

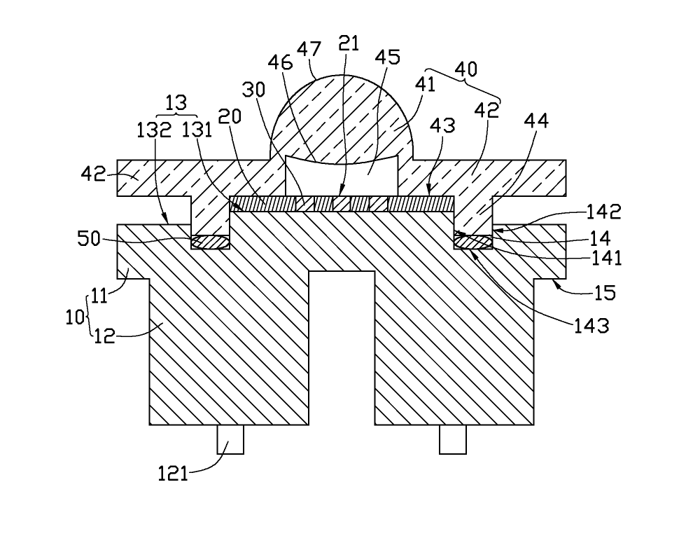

### BACKGROUND

1. Technical Field

The present disclosure relates generally to lamps, and more particularly to a light emitting diode (LED) lamp having a good waterproof performance

2. Description of Related Art

Water entering into an LED lamp could bring damage to electronic elements such as LED modules of the LED lamp. Usually, the LED lamp has a waterproof structure to prevent the water from entering into the LED lamp and protect the LED modules therein. Typically, a sealing ring is sandwiched between a lens and a housing of the LED lamp and functions as the waterproof structure. The sealing ring is made of resin or plastic. The waterproof structure cannot effectively block water from entering the LED lamp after a period of use of the LED lamp.

What is needed therefore is an LED lamp having a waterproof structure which can overcome the above limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Moreover, in the drawing, like reference numerals designate corresponding parts throughout the whole view.

The only drawing is a cross-sectional view of an LED lamp in accordance with an embodiment of the present disclosure.

### DETAILED DESCRIPTION

The only drawing illustrates an LED lamp in accordance with an embodiment of the present disclosure. The LED lamp comprises a heat sink 10, a heat dissipating layer 20 mounted on the heat sink 10, an LED module 30 slugged in the heat dissipating layer 20, and a lens 40 covering the LED module 30.

The heat sink 10 is made of material with high heat conductivity such as aluminum, copper or an alloy thereof. The heat sink 10 comprises a base 11 and two blocks 12 extending from a bottom surface 15 of the base 11. The blocks 12 can be configured as finned configuration for increasing a heat dissipating surface of the heat sink 10. A finned protrusion 121 extends downwardly from a bottom end of each block 12. A groove 14 is defined in a top surface 13 of the base 11, functioning as a waterproof groove. The groove 14 can be of annular, rectangular or elliptical shape in a top view. The groove 14 has an inner wall 141 adjacent to the LED module 30, an outer wall 142 apart from the inner wall 141 and a bottom face 143 interconnecting the inner and outer walls 141, 142. The outer wall 142 is far away from the LED module 30 compared with the inner wall 141. In this embodiment, the inner wall 141 and outer wall 142 are parallel to each other and substantially perpendicular to the bottom face 143. The inner wall 141 is higher than the outer wall 142. The top surface 13 of the heat sink 10 is divided by the groove 14 into two parts, that is, a center portion 131 and a periphery portion 132. The center portion 131 is surrounded by the inner wall 141 of the groove 14. The periphery portion 132 is formed out of the outer wall 142 of the groove 14 and surrounds the center portion 131. The center portion 131 is higher than the periphery portion 132. The center portion 131 is provided for mounting the LED module 131 thereon.

The heat dissipating layer 20 is adhered on the center portion 131 of the heat sink 10. A plurality of notches 21 are defined in the heat dissipating layer 20 for receiving the LED module 30 therein. The heat dissipating layer 20 can absorb heat generated from the LED module 30 and conduct the heat to the heat sink 10.

The LED module 30 is mounted on the center portion 131 of the heat sink 10 and comprises a plurality of LEDs (not labeled) each slugged in a corresponding notch 21 of the heat dissipating layer 20.

The lens 40 is made of transparent or translucent material such as glass, resin etc., for light emitted by the LED module 30 passing therethrough. The lens 40 comprises a light extraction portion 41 and a mounting portion 42. The light extraction portion 41 is corresponding to the LED module 30. The mounting portion 42 surrounds the light extraction portion 41. A part of a bottom surface 43 of the mounting portion 42 of the lens 40 engages with the heat dissipating layer 20. A looped flange 44 extends downwardly from the bottom surface 43 and inserts into the groove 14 of the heat sink 10. Specifically, the flange 44 and the groove 14 have an identical width for the flange 44 fittingly matching with the groove 14. A waterproof ring 50 is received in the groove 14. The thickness of the waterproof ring 50 is less than the height of the outer wall 142 of the groove 14. The flange 44 has a predetermined height such that when the bottom surface 43 of the mounting portion 42 closely engages with the heat dissipating layer 20, a bottom surface (not labeled) of the flange 44 tightly engages with the waterproof ring 50.

The light extraction portion 41 covers the LED module 30 and spaces apart from the LED module 30 to define a space 45. The light extraction portion 41 has an inner surface 46 protruding to the LED module 30 and an outer surface 47 protruding away from the LED module 30. The light extraction portion 41 is so configured to form a lens portion whereby when light generated by the LED module 30 transmits through the light extraction portion 41 a desired light pattern is obtained. Understandably, the light extracting portion 41 of the lens 40 can also be in alternative shapes other than the shape shown in the only drawing.

The center portion 131 of the heat sink 10 is higher than the periphery portion 132 and the center and periphery portions 131, 132 are separated by the groove 14. It is difficult for water or the like to enter into the lens 40 of the LED lamp due to the blocking of the higher center portion 131. Therefore, the LED module 30 of the present disclosure which is mounted on the center portion 131 and covered by the lens 40 is prevented from the damage by water or the like.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED lamp comprising:
a heat sink having a top surface and a bottom surface opposite to the top surface;
an LED module mounted on the top surface of the heat sink; and
a lens engaged with the heat sink and covering the LED module;
wherein a waterproof groove is defined in the top surface of the heat sink, the groove having an inner wall adjacent to the LED module and an outer wall far away from the LED module, the inner wall being higher than the outer wall.

2. The LED lamp of claim 1, wherein a flange is formed at a bottom surface of the lens and inserted into the groove of the heat sink.

3. The LED lamp of claim 2, wherein a waterproof ring is received in the groove and pressed by the flange of the lens.

4. The LED lamp of claim 3, wherein a thickness of the waterproof ring is less than a height of the outer wall of the groove.

5. The LED lamp of claim 1, wherein a heat dissipating layer is mounted on the top surface of the heat sink with a plurality of notches defined therein, the LED module being received in the notches.

6. The LED lamp of claim 5, wherein the lens has an inner surface protruding to the LED module and the heat dissipating layer, and an outer surface protruding away from the LED module, a space is defined between the inner surface of the envelop and the heat dissipating layer.

7. The LED lamp of claim 1, wherein a plurality of blocks are formed on the bottom surface of the heat sink.

8. An LED lamp comprising:
a heat sink having a top surface and a bottom surface, a waterproof groove being defined in the top surface to divide the heat sink into a center portion and a periphery portion departing from and surrounding the center portion, the center portion being higher than the periphery portion;
an LED module mounted on the center portion of the heat sink; and
a lens engaged with the heat sink and covering the LED module, the lens having a flange extending downwardly therefrom and inserted into the groove of the heat sink.

9. The LED lamp of claim 8, wherein the groove has an inner wall, an outer wall apart from the inner wall, and a bottom face interconnecting with the inner and outer walls, the inner wall being adjacent to the LED module, the outer wall being far away from the LED module.

10. The LED lamp of claim 9, wherein a waterproof ring is received in the groove and pressed by the flange of the lens, and a thickness of the waterproof ring is less than a height of the outer wall of the groove.

11. The LED lamp of claim 8, wherein a heat dissipating layer is mounted on the center portion of the heat sink with a plurality of notches defined therein, the LED module being received in the notches.

12. The LED lamp of claim 8, wherein the lens comprises a light extraction portion corresponding to the LED module and a mounting portion surrounding the light extraction portion, the flange extending downwardly from a bottom surface of the mounting portion.
